(19) United States
(12) Patent Application Publication
(10) Pub. No.: US 2004/0090303 A1
(43) Pub. Date: May 13, 2004

(54) Electrical component and method for producing the same

(76) Inventors: Harald Schopf, Lienz (AT); Thomas Trenkler, Thal (AT); Chong Wang, Munich (DE)

Correspondence Address: FISH & RICHARDSON PC, 225 FRANKLIN ST, BOSTON, MA, 02110, US

(21) Appl. No.: 10/450,593

(22) PCT Filed: Dec. 13, 2001
(86) PCT No.: PCT/DE01/04688

(30) Foreign Application Priority Data
Dec. 14, 2000 (DE) 100 62 293.3

(51) Int. Cl. H01C 7/10

(52) U.S. Cl. 338/22 R

(57) ABSTRACT

The invention relates to an electrical component having a basic body (1), at least two connector elements (4, 5) connected with the basic body (1), an intermediate layer (6) arranged on the surface of the basic body (1), and a protective layer (7) arranged on the intermediate layer (6), wherein the intermediate layer (6) and the protective layer (7) are each produced from the same varnish, containing a solvent, and wherein the intermediate layer (6) has a lower content of solvent than the protective layer (7). Furthermore, the invention relates to a method for the production of the component. It is particularly advantageous if the intermediate layer (6) is applied by being sprayed onto the heated basic body (1) of the component. In this way, the voltage storage stability of the PTC [sic] resistor is increased.

The invention relates to an electrical component having a basic body, at least two connector elements connected with the basic body, as well as a protective layer. Furthermore, the invention relates to a method for the production of the component.

Electrical components of the type stated initially are known, whose basic bodies are produced from a ceramic material having a positive temperature coefficient of the ohmic resistor. Furthermore, the basic body of the known components is sheathed with a protective layer containing organic ingredients. Such components are generally used as PTC resistors. In this connection, donator-doped and acceptor-doped barium titanate, for example, is used as the ceramic material. The protective layer is usually a dried varnish applied to the basic body by means of a dip-varnishing method, which contains organic solvents, such as xylene or acetol ester, and organic binders.

From the reference DE 25 00 789 A1, electrical components having a compressible intermediate layer are known, onto which a protective layer is applied. The intermediate layer serves to absorb tension forces that act on the basic body because of different thermal expansion coefficients of the electrical basic body and the protective layer. In this connection, the intermediate layer can consist of a material containing a solvent, the solvent proportion of which was evaporated by heating the material after it was applied to the basic body.

From the patent DE 51 956 C2, a PTC resistor is known that is surrounded by a housing, the material of which is free of nucleophiles. In this way, a chemical reaction of the housing material with the basic body of the PTC resistor can be prevented. The housing is encapsulated by a casting material.

The PTC resistors are assessed, with regard to their quality, by means of their voltage storage stability, among other things. The voltage storage stability indicates what electrical voltage the PTC resistor can withstand over an extended period of time, such as 24 hours, without losing its characteristic properties. Because of the voltage applied, a current flows through the PTC resistor, heating it up. Therefore the voltage storage stability of the PTC resistor is closely linked with its temperature stability. Since chemical processes with significant time constants play a role for the assessment of the stability of a PTC resistor, among other things, an electrical voltage applied only over a short period of time does not provide enough information for an assessment of the stability.

The known components have the disadvantage that the varnish applied as a protective layer has a relatively high layer thickness, between 10 and 500 μm, because of the dip varnishing method. Therefore, encrusted surfaces are formed on the surface when the varnish dries, while a proportion of organic ingredients is still present in the interior of the varnish, which is prevented from completely leaving the varnish during the further progression of the drying process, because of the encrusted surfaces.

Therefore, the protective layer of the known components contains a residue of organic ingredients. These ingredients can reach the basic body, and can result in a chemical reaction there, if the temperature of the component exceeds 220° C. because of a very high applied voltage, which reaction depolarizes the grain borders of the ceramic. This destroys the PTC effect of the ceramic, causing the component to overheat if the voltage continues to be applied, and therefore to be destroyed. Therefore, the known components demonstrate poor voltage storage stability.

It is therefore the goal of the present invention to make available a component that demonstrates a high level of voltage storage stability. Furthermore, it is a goal of the invention to indicate a method for the production of such a component.

These goals are achieved, according to the invention, by means of a component according to claim 1, as well as by a method according to claim 8. Advantageous further developments of the invention are found in the additional claims.

The invention indicates an electrical component having a basic body and at least two connector elements that are connected with the basic body. An intermediate layer is arranged on the surface of the basic body, which layer has a protective layer on its surface. In this connection, the intermediate layer and the protective layer are each made from the same material, which contains a solvent. In addition, the intermediate layer has a lower content of the solvent than the protective layer.

The component according to the invention has the advantage that the two layers arranged on the surface of the basic body are produced from the same material, making it possible to do without the use of different materials, with the effect of cost savings. Furthermore, the component according to the invention has the advantage that the intermediate layer making direct contact with the surface of the basic body has a lower content of solvent than the protective layer. As a result, the basic body of the component, which can consist of a ceramic material, for example, comes into contact with less solvent, thereby making it possible to reduce the negative effects of the solvent, as described in the introduction.

The intermediate layer arranged on the surface of the basic body can be applied to the basic body in such a way that the latter is heated during application of the intermediate layer. This results in the advantage that at least part of the solvent contained in the starting material can evaporate during application of the intermediate layer, and that the intermediate layer on the surface dries quickly. This effectively reduces the content of solvent in the intermediate layer as compared with the protective layer.

It is particularly advantageous if heating of the basic body takes place by means of producing an electrical current. For this purpose, PTC resistor ceramics are particularly suitable as a material for the basic body, since they are designed for stress resulting from high currents.

Furthermore, a varnish that contains an organic solvent can be used as the starting material for the intermediate layer or for the protective layer. Such varnishes are usually used as a protective layer for PTC [original contains a typographical error—PCT] resistors structured using PTC resistor ceramics. The organic ingredients can be aromatic solvents, such as xylene, acetol ester, ethylene benzene, or also butanol, or organic binders, such as silicate rubber, among other things. Protective layers produced from such materials protect the component against ambient influences and demonstrate sufficient insulating properties, so that no short circuit between the connector elements is produced by the layers. In particular, varnishes that contain the organic ingredients described above, as well as inorganic fillers, such as SiO2, are possible materials for the layers.

It is advantageous if the protective layer is produced by dipping the basic body into a liquid, since it is possible to produce an external protective layer with a thickness suitable for the component with such a process, in simple manner.

Such a suitable thickness, which is necessary for the protective function of the protective layer, lies between 10 and 500 μm. A suitable layer thickness for the intermediate layer lies in the range between 5 and 100 μm.

Furthermore, the invention indicates a method for the production of an electrical component, wherein the component comprises a basic body that is contacted with at least two connector elements and has an intermediate layer produced from a starting material that contains a solvent, on its surface, and wherein the basic body is heated by means of an electrical current flowing through it during application of the intermediate layer.

Heating of the basic body during application of the intermediate layer has the advantage that the solvent contained in the starting material can easily evaporate, making it possible to reduce the solvent content of the intermediate layer and thereby also the effects of the solvent on the surface of the basic body.

In particular, the method according to the invention is suitable for producing the intermediate layer of the component according to the invention.

It is particularly advantageous to apply the starting material for the production of the intermediate layer to the basic body by spraying it on. In this connection, all the known spraying methods can be used, including the air brush method, for example. Spraying of the starting material makes it possible to apply the intermediate layer continuously and in a thin layer, wherein a layer application with a homogenous layer thickness is particularly possible. Because the intermediate layer grows very slowly when it is applied by means of spraying, the content of solvent can easily evaporate during application of the intermediate layer.

Furthermore, by applying the intermediate layer by means of spraying, it is easily possible to surround the basic body of the component with the intermediate layer on all sides, causing the access of moisture to the basic body, i.e., of solvent of a protective layer arranged on the intermediate layer, to be effectively prevented.

In the case of application of the intermediate layer by means of spraying, it is particularly advantageous if the basic body is heated to a temperature that causes at least 90% of the solvent proportion of the starting material to evaporate during application of the intermediate layer. This ensures that the intermediate layer contains only a very small proportion of solvent.

Making application of the layer uniform can be achieved in that the actual temperature of the basic body during application of the intermediate layer is stabilized in such a way that it deviates from a suitable reference temperature by less than 10%. This ensures that, on the one hand, the temperature of the basic body is so high, at all times during the application process, that a sufficient amount of solvent is evaporated, and, on the other hand, that the temperature is so low that the intermediate layer and the basic body are not subject to thermal damage.

In this method, it is advantageous to use a basic body whose U-I characteristic has at least one maximum. It is then possible to produce the electrical current that flows through the basic body by applying an electrical voltage to the connector elements, which voltage lies in a range of negative incline of the U-I characteristic. Because of the negative incline of the characteristic, an increase in the voltage results in a drop in the current flowing through the component, which has a stabilizing effect on the transformed electrical power P and thereby also on the temperature of the component, i.e., of the basic body.

A basic body made of a PTC resistor ceramic is possible for use as a basic body having a U-I characteristic with at least one maximum. The selection of an electrical voltage that lies in a range of negative incline of the U-I characteristic is known as “tipping” for PTC resistors.

Donator-doped barium titanate or also a (V,Cr)2O3 ceramic, for example, are possibilities for a suitable material for the ceramic with a positive temperature coefficient.

When using a basic body made from a PTC resistor ceramic, the basic body can be heated to a temperature between 140 and 150° C. by means of a current between 1 and 2 A. Such a temperature is suitable, for example, for spraying on a layer of silicate varnish.

A protective layer made of the same starting material can be applied to the intermediate layer by means of a different method, such as dipping. Such a protective layer can be made thicker than the intermediate layer and is then suitable as a protective layer against ambient influences.

By spraying the starting material onto the basic body, the intermediate layer can be applied to the basic body to surround it on all sides, in particular, thereby effectively protecting the basic body against other outer layers that contain solvent.

In the following, the invention will be explained in greater detail, using exemplary embodiments and the related figures.

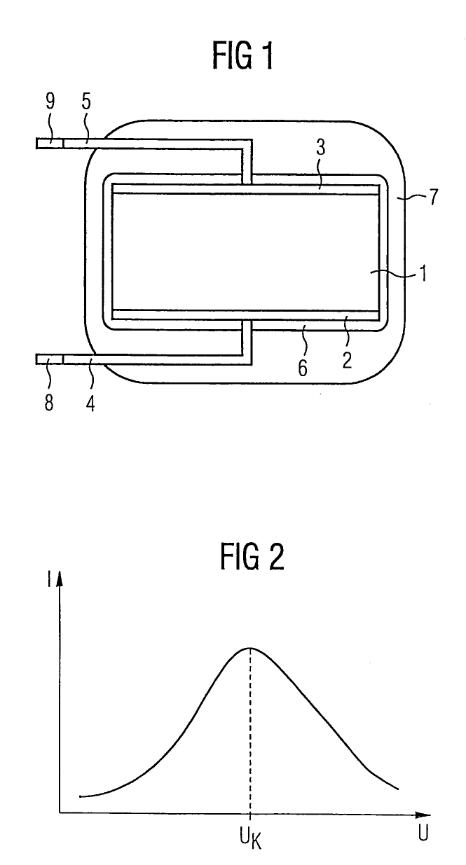

FIG. 1 shows a component according to the invention, as an example, in schematic cross-section.

FIG. 2 shows the U-I characteristic of the component from FIG. 1, as an example.

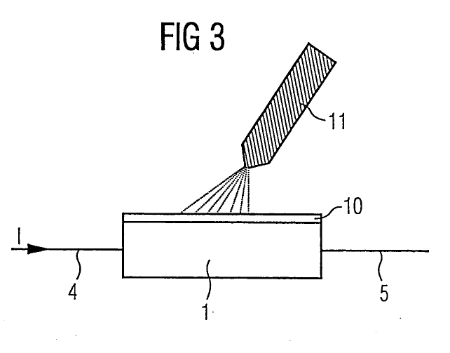

FIG. 3 shows a component during the application of a layer, using the method according to the invention, as an example, in schematic cross-section.

FIG. 1 shows a PTC resistor having a disk-shaped basic body 1, which consists of a suitable ceramic. A first contact region 2 is provided on the bottom of the basic body 1, which region can consist, for example, of a silver baked enamel paste. A first connector element 4 is attached at the first contact region 2, wherein this element can be a wire, for example. The attachment of the wire to the first contact region 2 is preferably accomplished by means of soldering. A second contact region 3 is arranged on the top of the basic body 1, which in turn can consist of a silver baked enamel paste. In the same manner as on the first contact region 2, a second connector element 5 in the form of a soldered wire is also attached at the second contact region 3.

The basic body 1 is sheathed by a protective layer 6 [sic—should be 7], which has a thickness of 10 to 500 μm and consists of a varnish containing a solvent. Furthermore, the basic body 1 is sheathed by an intermediate layer 7 [sic—should be 6] arranged within the protective layer 6 [sic—see above], which is between 5 and 20 μm thick and has only a very slight proportion of solvent. The connector elements 4, 5 have end segments 8, 9 that are not sheathed by either of the layers 6, 7, so that they can serve for electrical contacting of the component.

In an exemplary embodiment of the invention, an amount of 20 pieces of the components shown in FIG. 1 was produced as follows:

A PTC component was heated to a temperature between 140 and 150° C. by means of a current of 1 to 2 A. After stabilization of the temperature, an intermediate layer 6 was applied by spraying silicate varnish on using an air brush. Subsequently, a protective layer 7 was produced by dipping the PTC, which had cooled again in the meantime, into silicate varnish and subsequently drying it.

Furthermore, 20 components according to FIG. 1, but without an intermediate layer, were produced as comparison samples.

The silicate varnish from the Reichold company was used for production of the protective layer, both for the exemplary embodiments of the invention and for the comparison samples; this varnish has been shown to lower the voltage storage stability to a particular degree.

The storage of components at 20 V alternating current was tested for a period of 24 hours. In the case of the components according to the invention, no failures were observed after this voltage storage test, while seven failures were observed for the components without an intermediate layer. This clearly shows the positive effect of the intermediate layer according to the invention.

The U-I characteristic according to FIG. 2 shows a maximum at a tip voltage UK. For voltages U>UK, the PTC resistor can be “tipped,” which means that when the voltage U increases, the current I flowing through the PTC resistor decreases, and therefore the electrical power transformed in the component can be stabilized.

FIG. 3 shows the implementation of the method according to the invention, wherein a basic body 1 made of a PTC resistor ceramic, which is provided with connector elements 4 and 5, has an electrical current I flowing through it. This electrical current I heats the basic body 1 to a temperature above room temperature. Using a nozzle 11, silicate varnish can now be sprayed onto the surface of the basic body 1, so that a layer 10 is formed, which contains only a very small amount of solvent, because of evaporation.

1. CT resistor having
a basic body (1),
at least two connector elements (4, 5) connected with the basic body (1),
an intermediate layer (6) arranged on the surface of the basic body (1), and
a protective layer (7) arranged on the intermediate layer (6),
in which the intermediate layer (6) and the protective layer (7) are each produced from the same varnish, containing a solvent, wherein the solvent has a negative influence on the electrical properties of the component, and
in which the intermediate layer (6) has a lower content of solvent than the protective layer (7).

2. Component according to claim 1,
in which the thickness of the intermediate layer (6) is between 5 and 100 μm.

3. Component according to claim 1,
in which the thickness of the protective layer (7) is between 10 and 500 μm.

4. Method for the production of a PTC resistor having a basic body (1) that is contacted with at least two connector elements (4, 5), including the process steps:
A) An intermediate layer (6) consisting of a varnish containing a solvent is produced on the basic body (1), wherein the latter is heated by means of an electrical current (I) during application of the intermediate layer, so that at least 90% of the solvent proportion of the varnish evaporates during application of the intermediate layer (6).
B) A protective layer (7), consisting of a varnish containing a solvent, is produced on the intermediate layer (6).

5. Method according to claim 4,
wherein the intermediate layer is applied to the basic body (1) by means of spraying.

6. Method according to claim 4 or 5,
wherein a basic body (1) is used, whose U-I characteristic has at least one maximum, and wherein the electrical current (I) that flows through the basic body (1) is produced by application of an electrical voltage (U), which lies in a range of negative incline of the U-I characteristic, so that the actual temperature of the basic body (1) during application of the intermediate layer (6) is stabilized in such a way that it deviates from a reference temperature by less than 10%.

7. Method according to claim 4 to 6,
wherein the basic body (1) is heated to a temperature between 140 and 150° C.

8. Method according to claims 4 to 7,
wherein the protective layer (7) made from the same material as the intermediate layer (6) is applied in process step B).

9. Method according to claim 8,
wherein the protective layer (7) is applied by dipping into a liquid.

10. Method according to claim 4 to 9,
wherein the intermediate layer is applied in such a manner that it surrounds the basic body (1) on all sides.
